(19) United States
(12) Patent Application Publication
(10) Pub. No.: US 2009/0223385 A1
(43) Pub. Date: Sep. 10, 2009

(54) HOME CHEESE CURD MAKING DEVICE

(76) Inventor: TIMOTHY W. HEALD, Nampa, ID (US)

Correspondence Address: DYKAS, SHAVER & NIPPER, LLP, P.O. BOX 877, BOISE, ID, 83701-0877, US

(21) Appl. No.: 12/399,807

(22) Filed: Mar. 6, 2009

Related U.S. Application Data
(60) Provisional application No. 61/034,478, filed on Mar. 6, 2008.

(51) Int. Cl. A01J 25/06; A23C 19/024

(52) U.S. Cl. 99/453; 99/456; 99/459; 99/460

(57) ABSTRACT

A cheese making appliance with a cooking vessel, a curd stirring assembly in the cooking vessel, and a controller for the cooking vessel and stirring assembly. The controller controls the temperature of the cooking vessel over a period of time, and turns the stirring assembly on and off and controls its speed, depending on the programmed cycle for a particular type of curd product that is to be made.

### PRIORITY/CROSS-REFERENCE TO RELATED APPLICATIONS

This application claims the priority date of the provisional application entitled Home Cheese Making Device filed by Timothy W. Heald on Mar. 6, 2008 with application Ser. No. 61/034,478, the disclosure of which is incorporated by reference.

### FIELD OF THE INVENTION

The invention generally relates to an apparatus for making cheese, and more particularly to a home food processing appliance for processing milk into cheese curd.

### BACKGROUND OF THE INVENTION

The process of making cheese curds for consumption or for creating consumable cheeses is very tedious and precise. It requires exacting control over the time/temperature of the milk/coagulum/curd mass and gentle, timely stirring of the mass to promote the uniform and timely curd formation necessary for quality cheese curds for a desired type of cheese. Cheese making is an age old process, and is done commercially in large equipment. What is needed is a device small enough to be used in a home to make family sized quantities of cheese. Such a device also needs heating and stirring process controls, and a stirring mechanism.

### SUMMARY OF THE INVENTION

Objectives of the invention include providing a small, easy to use appliance for use in the home kitchen that is capable of producing a variety of cheese curd products suitable for processing into a variety of cheeses.

Another objective is to provide a small, easy-to-use appliance for use in the home kitchen that is capable of producing other milk-based coagulum, non-curding products such as cream cheese and yogurt, in addition to being able to pasteurize raw milk.

These objectives are accomplished by this invention, which includes a cooking appliance, a rotary cheese curd stirrer, and an electronic controller unit. The cooking appliance consists of a cooking vessel and a cooking vessel lid which closes the cooking. This can take the form of a heat unit into which the cooking vessel can be placed. The heating unit can also be built into the cooking unit, as in a slow cooker.

A rotary stir assembly is included, and is configured to rotate near the bottom of the cooking vessel to stir the curd as it forms from milk. An upper stir assembly can be included, to aid in stirring the curd in the cooking vessel.

As the heating unit provides heat to the cooking vessel, the rotary cheese curd stirrer scrapes the bottom of the cooking vessel and mixes the contents, in order to assure a consistent temperature throughout and prevent the milk-based contents from scalding or burning. An electronic controller unit is included, and is configured to control both the temperature of the cooking vessel and the timing, direction, and speed of the stirring action of the rotary cheese curd stirrer in such a manner as to produce the desired products.

One version of the device has a rotary cheese curd stirrer which forms a lower stir assembly that, in addition to stirring and preventing scalding and burning, prevents the curds from matting and settling to the bottom of the cooking vessel with an upper stir assembly and stir paddles on both the upper and lower stir assemblies. The stir paddles on the upper stir assembly can form a solid, or partially solid, stationary curtain to provide counter stirring against the rotary cheese curd stirrer and paddles. Further, the upper and lower stir paddles are configured in such a manner as to be inclined, in order to rake the curds down from the top and lift the curds up from the bottom. The upper stir paddles extend between the lower stir paddles in such a manner as to shear any matted cheese curds. The upper stir assembly may also be configured so as to rotate in the opposite direction of the rotary cheese curd stirrer in order to provide improved counter stirring of the curds.

A preferred home cheese making device has an electronic controller unit that senses the temperature of material inside the cooking vessel through the use of an infrared sensor or an immersion sensor. Using predefined and user defined recipes, the controller turns the heating unit on or off as needed to achieve and maintain the temperatures necessary to produce the selected product. In addition, the controller starts and stops the rotary action of the rotary cheese curd stirrer as needed to produce the selected product, and controls the speed and direction of rotation of the upper and lower stirring assemblies.

The standard procedure for making most types of cheese curds can consist of up to six distinct steps. Each step can consist of any or all of the following parameters: duration time, start temperature, end temperature, mixer on duration, mixer off duration, mixer delay and step indicator. The six step indicators are: Preheat, Ripen, Curd, Cook, Warm 1, and Warm 2. All parameters are dependent upon the type of cheese curd/coagulum being made, e.g., the parameters for cheddar cheese curds will be different than the parameters for Parmesan cheese curds or yogurt coagulum.

The first step is to preheat the milk to starting temperature while stirring occasionally. The second step is ripening, wherein the milk is kept at a constant temperature for a desired period of time while stirring occasionally. The third step is curd where the milk becomes a coagulum mass and is kept at a constant temperature for a period of time with no stirring. The fourth step is cook, where the temperature of the cubed coagulum mass is slowly raised from the coagulating temperature to the final cook temperature over a period of time—generally around one degree F. per minute. During this fourth cook step, the mass must be gently stirred occasionally to prevent the cubed coagulum mass settling at the bottom of the cooking container. This stirring keeps the cubes of coagulum suspended in the whey, which allows the cubes of coagulum to eject the whey and become curds. The cubes of coagulum begin as very fragile entities and can be easily mashed in the stirring action. Thus, the control of the stirrer mechanism is critical. The stirrer cycle can be delayed for a period of time—called healing—and then mixing begins. The optional fifth and sixth steps are the warm steps where the cheese curd and whey solution are kept at a constant temperature with or without stirring as determined by the cheese curd recipe.

This invention accurately and precisely performs these steps as necessary for a desired type of cheese curd. This invention allows existing home kitchen cooking devices, such as a rice cooker, slow cooker or a pot on a heating surface, to be used to make quality cheese curds for a variety of cheeses. In addition, the precise time/temperature control feature of the invention allows the invention to be a versatile cooking device—such as a rice cooker, steamer, slow cooker, yogurt maker, and milk pasteurizer.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF DRAWINGS

FIG. 1 is a side cross sectional view of the device of the invention

FIG. 2 is a plane view of a control panel of the invention.

FIG. 3 is a side view of a control panel of the invention.

FIG. 4 is a view of the bottom of the control panel.

FIG. 5 is a top view of a curd stirrer of the invention.

FIG. 6 is a side view of a curd stirrer of the invention with a stationary paddle.

FIG. 7 is a side view of a curd stirrer of the invention.

FIG. 8 is a side view of a version of the upper and lower stirrers of the invention.

FIG. 9 is a side view of a scraping portion of a curd stirrer.

FIG. 10 is a top view of a stirring arrangement of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

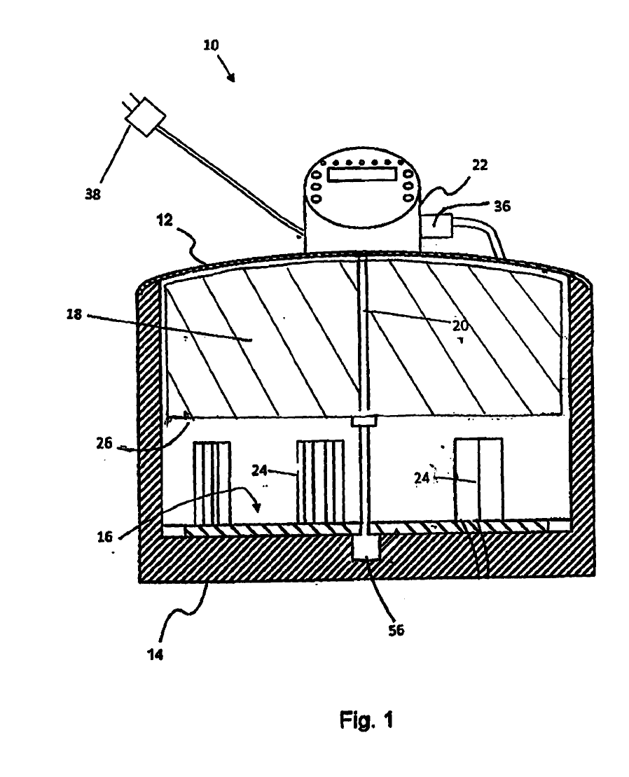

The invention is a portable countertop food processing appliance, configured for the preparation of cheese curds from milk. One version of the cheese making appliance of the invention is shown in FIG. 1. The version shown in FIG. 1 includes a cooking vessel 14 and a cooking vessel lid 12. Also shown in FIG. 1 is a rotary cheese curd stirrer 16 and an upper stir assembly 18. The rotary cheese curd stirrer 16 is configured to rotate inside the vessel 14 and is driven by a drive shaft 20. The drive shaft 20 is powered from an electronic controller unit 22 which includes a motor 56. In the configuration shown in FIG. 1, the rotary cheese curd stirrer 16 includes a number of stir paddles 24, which break up coagulated cheese curd, and also scrape the bottom of the cooking vessel 14. A cross-section of part of the cheese curd stirrer is shown in FIG. 9. A bottom edge 26 of the cheese curd stirrer 16 travels on or close to the bottom of the vessel 14, and tends to scrape cheese curd which may accumulate on the bottom of the vessel.

In the version shown in FIG. 1, the upper stirrer assembly 18 is a vane which is approximately as wide as the diameter of the cooking vessel 14. The vane can be a solid or perforated plastic unit which can be fairly thin, with a bottom edge 26. Bottom edge 26 may be straight or toothed to intermesh with the stir paddles 24 of the rotary cheese curd stirrer 16. The upper stir assembly can be configured to be stationary, and in its stationary position it would provide counter stirring against the cheese curd being rotated and agitated by the cheese curd stirrer 16.

The upper stir assembly can also be configured by appropriate gearing to rotate in a direction counter to the direction of the rotary cheese curd stirrer 16, or in the same direction but at a different speed. In either a stationary or a counter rotating configuration, counter stirring is provided against the rotary cheese curd stirrer 16. The drive shaft shown in FIG. 1 can be attached to a motor in the cooking vessel lid, or it may be attached to a motor in the base of the cooking vessel 14.

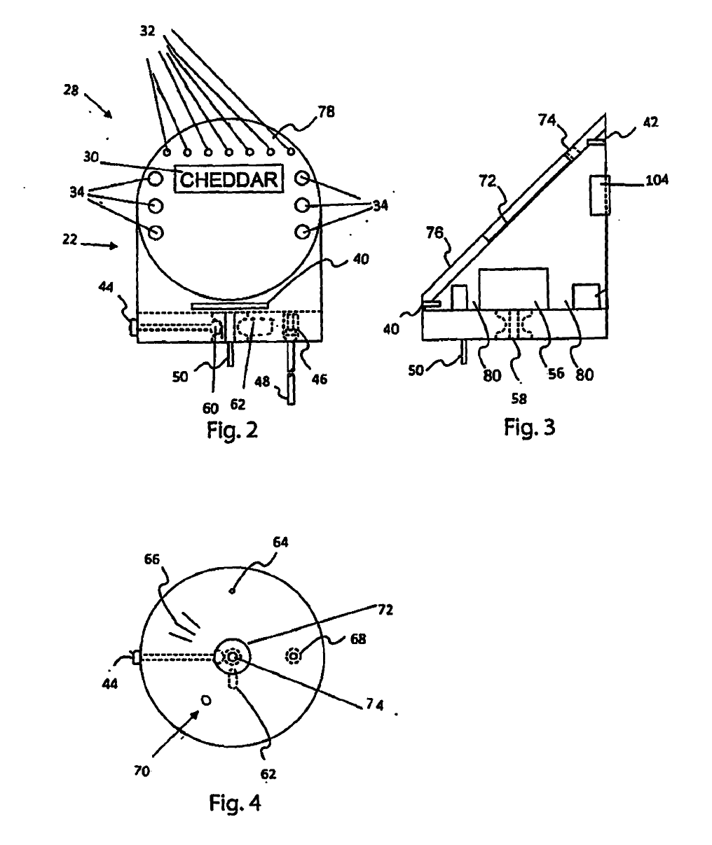

FIG. 2 shows a view of the interface console 28 of the electronic controller unit 22. The interface console 28 of the electronic controller unit 22 provides a display 30, status indicators 32, and selection buttons 34 that allow the use to select the program which controls the operation of the device. These operations include the selection of any of the fourteen or more of any curd recipes including: eight cheese curd recipes; two coagulum recipes; two user defined recipes, rice cooker and slow cooker programs; modification of the recipe parameters in starting, stopping and pausing the cheese curd making operation. For operation, the cooking vessel lid 12 with the electronic controller unit 22 is placed on the cooking vessel 14. The power cord of the cooking vessel may be may be connected to the electronic controller unit 22 with the power cord 38, and the electronic controller unit can them be plugged into an electrical power source. One power cord can also supply power to both units.

The embodiment of the invention shown in FIG. 1 can also be made as a two piece unit in which the two pieces are sold together, the two pieces being the cooking vessel 14 and the cooking vessel lid 12, with its attached electronic controller unit 22 and attached cheese curd stirrer 16 and upper stir assembly 18.

One preferred embodiment of the invention includes an electronic controller unit, and a container lid and matching container, which may be made of stainless steel, crockery or other suitable material. A base unit may be a separate unit, consisting of a gas or electric cooking device capable of heating the said container, to which the mixer/sensor head is wired directly, and on which an electronic controller unit is installed; and a rotary cheese curd stirrer. The interface console of the electronic controller unit provides a display, status indicators, and buttons that allow the user to select the operation of the device. These operations include a selection of any of the 14 or more recipes including: eight cheese curd recipes; two coagulum recipes; two user definable recipes, rice cooker and slow cooker; modification of the recipe parameters; and starting, stopping and pausing the cheese curd making operation. For operation, the mixer/sensor head, lid, and stirring mechanism assembly is placed on/in the container and the container is placed on the base unit which is plugged into an electrical power source.

FIGS. 2-4 depicts a preferred embodiment of the electronic controller unit in three views. FIG. 2 depicts the layout of the operator interface of the electronic controller unit. FIG. 2 shows a representation of the operator interface with respect to the controller unit. Also visible in FIG. 2 is a lower vent slot 40 that allows air to pass through the upper portion of the unit and cool the microprocessor control system and travel out of the upper vent 42 shown in FIG. 3. FIG. 2 shows the lid release button 44 that is used to release the vessel lid 12 from the electronic controller unit 22, the locations of the infrared temperature sensor 46, and the optional thermistor temperature probe and the alignment pin 50. FIG. 3 shows the placement of the microprocessor control system in the vented upper section of the electronic controller unit 22, the vents, and the vinyl overlay 54 that form the operator interface. Shown in FIG. 2 is the interface system that interfaces the microprocessor control system 52 to the stirrer motor 56 and the 110 VAC heater receptacle by using relays; the infrared sensor or thermistor probe; and the 110 VAC power supply for energizing the controller. Also shown in FIG. 3 is the mixer mating connector that allows the rotary cheese curd stirrer mechanism 16 to be easily connected and disconnected to the stirrer motor 56 and the electronic controller unit 22. FIG. 4 shows the alignment pin 50 (optional hole or grooves and ridges 66), the lid knob recess hole 64, into which the lid knob (not shown) is latched, the infrared 46 or thermistor sensor 48, and the lid latched switch 62.

FIG. 4 depicts the bottom of the electronic controller unit 22. Shown are: the alignment hole 64 through which the alignment pin 50 passes, optional grooves and ridges 66 to align the lid, the temperature sensor hole 68 through which the temperature of the container contents is sensed, the vent hole 70 through which the heat and steam from the cooking vessel 14 contents are vented to the atmosphere, and the lid knob 72 with the sealed hole 74 through which the drive shaft 20 of the stirrer assembly passes. The lid knob 72 is of a form that allows it to be latched into the controller unit 22 and close the lid latch switch 62.

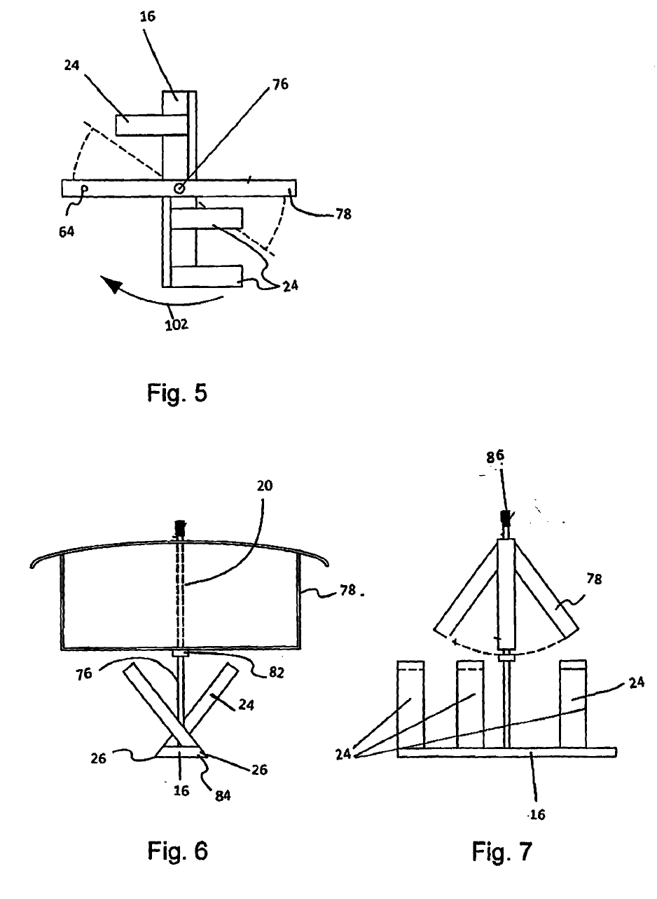

FIGS. 5-7 depict a version of the rotary cheese curd stirrer mechanism in three views. The stirrer mechanism consists of three major components: the drive shaft 20, the stationary paddle 78 and the cheese curd stirrer 16. FIG. 5 shows the orientation of the stir paddles 24 on the cheese curd stirrer 16 in respect to the stirrer rotation 100 and the alignment hole 64 (optional pin or grooves and ridges 66) in the stationary paddle 78. FIG. 6 shows the stationary paddle 78 riding on the guide 82 on the drive shaft 20 and the orientation of the leading edge of the cheese curd stirrer 16 and the stir paddles 24. As the cheese curd stirrer slowly rotates, the cubed coagulum mass is gently lifted from the bottom of the container by the leading edge 26 of the stirrer 16. The mass slides up the stir paddles 24 which separates the cubes when some fall back down between the fins. FIG. 7 shows a different view of the stir paddles 24 of the stirrer 16, and the mating end 86 of the drive shaft 20. Also shown are optional positions of the stationary paddle 78. Instead of remaining co-planar with the drive shaft 20, the stationary paddle may be inclined at an angle. This provides better vertical circulation of the cubed coagulum mass.

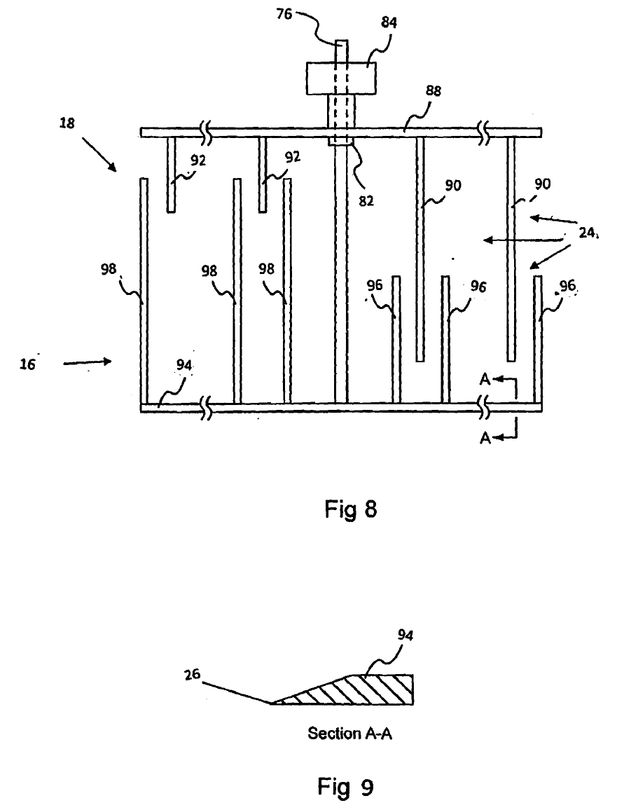

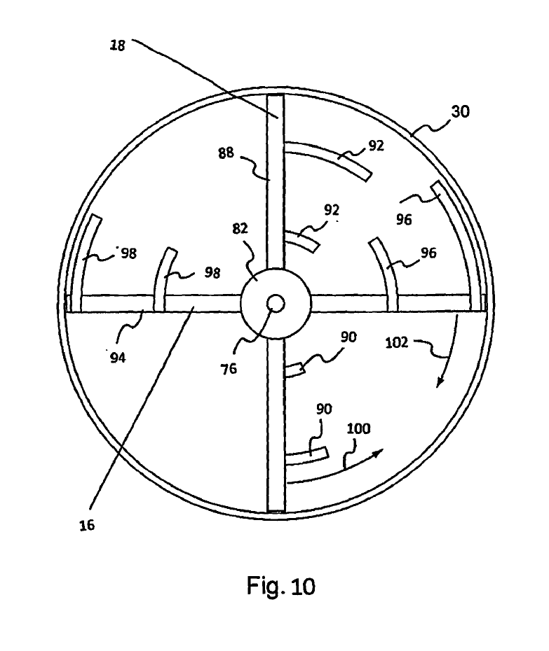

The upper stir assembly 18 and the rotary cheese curd stirrer 16 are shown in FIG. 8. The upper stir assembly 18 and the rotary cheese curd stirrer 16 may both be constructed out of a plastic or food grade material such as stainless steel. The upper stir assembly 18 consists of an upper support 88 that supports the helical upper rakes 90 and helical upper incline fins 92 and is driven in a rotary manner by the gearbox 84. The drive shaft 20 provides reverse torque to the gearbox 84 and to the rotary cheese curd stirrer and supports the upper stir assembly 18 on the guide 82. The rotary cheese curd stirrer 16 consists of bottom agitator 94 that supports the helical lower incline fins 96 and the helical lower rakes 98. FIG. 9 shows a cross-section of the bottom agitator 94 and shows the bottom agitator leading edge 26 which aids the rotary cheese curd stirrer 16 as it lifts the cubed coagulum mass off of the bottom of the cooking vessel 14 using the helical lower incline fins 96 as it rotates in the bottom agitator rotation direction 100 shown in FIG. 10. In addition, the helical lower rakes 98 drag the cubed coagulum mass down from the top and break up any matting that has occurred by dragging the matted curd through the helical upper incline fins 92. In a similar manner, the helical upper incline fins 92 push the cubed coagulum mass down from the top as it rotates in the upper support rotation direction 102 (shown in FIG. 10) while the helical upper rakes 90 drag the cubed coagulum mass up from the bottom and break up any matting that has occurred by dragging the matted curd through the helical lower incline fins 96. In this manner, the helical lower incline fins 96 create a vertical agitation motion while the helical upper rakes 90 and helical lower rakes 98 create a radial agitation motion, thus gently preventing the cubed curds from matting. The rotary speed, number of fins, number of rakes, dimensions, angles and geometry of the fins and rakes are dependent on the cooking vessel 14 depth and diameter.

FIG. 10 is a top view of one preferred embodiment of the stirring assembly of the invention. The upper stir assembly 18 is shown with upper support 88, gear box 84 attached to the upper support 88 are upper stir paddles 106, comprising helical upper incline fins 92 and helical upper rakes 90. The upper rakes 90 and the upper incline fins 92 are angled from their attachment to the upper support 88, so that they have different and opposite effects due to the rotation of the upper stir assembly 18. The upper stir assembly direction of rotation is indicated at 102, thus as the upper stir assembly 18 rotates counterclockwise, the helical upper incline fins 92 tend to lift cheese curds during their passage. However, as shown in FIG. 8, the helical upper incline fins are shorter than the helical upper rakes fins 90. As the upper stir assembly 18 rotates counterclockwise, the helical upper rakes 90 tend to slice through cheese curds and push them down. The upper helical rakes 90 are longer than the helical incline fins 92.

FIG. 10 also shows the rotary cheese curd stirrer 16 of the invention, which includes a bottom agitator 94 to which are attached the direction of rotation of the rotary cheese curd stirrer 16 is indicated as being counterclockwise.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A portable countertop food processing appliance for preparation of cheese curds from milk, comprising:
a cooking vessel with heating unit capable of variable heat production, configured to receive a milk based mixture and to heat said mixture in order to form cheese curd;
a cooking vessel lid for covering said cooking vessel;
a rotary cheese curd stirrer operatively connected to said cooking appliance for rotational stirring of said cheese curd, and configured to scrape said cooking vessel interior; and
an electronic controller unit operatively connected to said heating unit and said rotary cheese curd stirrer, comprising a data storage unit for storing one or more heating and stirring cycles of at least one cheese curd recipe, for controlling the temperature of said heating unit and for controlling the rotation of the stirrer mechanism according to a programmed heating cycle and a programmed stirring cycle.

2. The food processing appliance of claim 1 in which said rotary cheese curd stirrer is attached to said cooking vessel lid.

3. The food processing appliance of claim 1 in which said cheese curd stirrer is comprised of a stirrer attached to said cooking vessel.

4. The food processing appliance of claim 1 which further includes an upper stir assembly which contacts said cheese curd for counter stirring against said rotary cheese curd stirrer.

5. The food processing appliance of claim 4 in which said upper stir assembly further comprises a stationary vane which contacts said cheese curd for counter stirring against said rotary cheese curd stirrer.

6. The food processing appliance of claim 1 in which said cheese curd stirrer further comprises one or more stir paddles for stirring said cheese curd.

7. The food processing appliance of claim 4 in which said upper stir assembly further comprises a vertical vane with extending upper stir paddles which extend between said stir paddles of said cheese curd stirrer, for counter stirring against said rotary cheese curd stirrer.

8. The food processing appliance of claim 4 in which said upper stir assembly is configured to rotate in an opposite direction from said rotary cheese curd stirrer.

9. The food processing appliance of claim 1 in which said electronic controller unit further comprises a memory unit with stored recipes of a plurality of cheese curd products, which are selectable by a user at an electronic controller unit interface console.

10. The food processing appliance of claim 1 in which said electronic controller unit is configured to receive user entered instructions for a heating curve over a selected period of time, and for a stirring cycle over a period of time.

11. A portable countertop food processing appliance for preparation of cheese curds from milk comprising:
a cooking vessel with programmable heating unit, configured to receive a milk based mixture and to heat said mixture in a specified heating cycle coordinated with a stirring cycle, in order to form cheese curd;
a cooking vessel lid for covering said cooking vessel;
a rotary cheese curd stirrer operatively connected to said cooking appliance, comprising a plurality of stir paddles for rotation stirring said cheese curd, and configured to scrape said cooking vessel interior;
an upper stir assembly which comprises at least one upper stir paddle, configured to contact said cheese curd for counter stirring against said rotary cheese curd stirrer; and an electronic controller unit operatively connected to said heating unit and said rotary cheese curd stirrer and said upper stir assembly, comprising a control panel configured for a user to enter instructions for a heating cycle over a selected period of time, and for a stirring cycle over a selected period of time, said electronic controller unit for controlling the temperature of said heating unit and for controlling the speed, direction, and on/off state of rotation of the stirrer mechanisms according to a programmed heating cycle and a programmed stirring cycle.

11. The food processing appliance for preparation of cheese curds from milk of claim 1, in which said cooking vessel with heating unit is selected from the group comprising slow cookers, rice cookers, or heated cooking vessels, with said cooking vessel lid configured for attachment to a selected cooking vessel, and with said rotary cheese curd stirrer and said upper stir assembly and said electronic controller attached to said cooking vessel lid, and with said electronic controller configured for providing power to said cooking vessel in order to adjust temperature for a defined heating cycle.

12. The food processing appliance of claim 1 in which said curd stirrer further comprises: a driveshaft for providing rotational force; and
a gearbox configured to supply torque to said cheese curd stirrer via said drive shaft, and reverse torque to said upper stir assembly, with said upper stir assembly further comprising an upper support bar to which is fastened one or more upper stir paddles in the form of a helical upper rake and at least one helical upper incline fin;
with said curd stirrer further comprising a bottom agitator with a cross-section comprising a beveled leading edge and which further comprises one or more stir paddles in the form of at least one lower rake and at least one or more helical lower incline fins.

13. The food processing appliance of claim 1 in which said an electronic controller unit is configured to store and perform heating and stirring instructions for a number of different curd products, with said recipes selected from the group comprising cheeses, cream cheese, yogurt, ricotta, and other coagulum based products.

14. A portable countertop food processing appliance for preparation of cheese curds from milk comprising:
a cooking vessel with heating unit, configured to receive a milk based mixture and to heat said mixture in order to form cheese curd;
a cooking vessel lid for covering said vessel;
a rotary cheese curd stirrer operatively connected to said cooking appliance for rotation stirring of said cheese curd, with at least one stir paddle attached to said cheese curd stirrer, and configured to scrape said cooking vessel interior; and
an electronic controller unit operatively connected to said heating unit and said rotary cheese curd stirrer and configured to control heating and stirring over time, for controlling the temperature of said heating unit and for controlling the rotation of the stirrer mechanism according to a programmed heating cycle and a programmed stirring cycle, with said electronic controller including a user interface, selection buttons, and a status display, an audio notification speaker, and a storage device for storing one or more algorithms for precise temperature control based on content sensor, a heating element sensor, and a temperature sensor.
